(19) United States
(12) Patent Application Publication
(10) Pub. No.: US 2003/0136264 A1
(43) Pub. Date: Jul. 24, 2003

(54) Oil separator

(76) Inventor: Erhard Keller, Werneck (DE)

Correspondence Address: WILLIAM COLLARD, COLLARD & ROE, P.C., 1077 NORTHERN BOULEVARD, ROSLYN, NY, 11576, US

(21) Appl. No.: 10/239,281

(22) PCT Filed: Jan. 18, 2002
(86) PCT No.: PCT/DE02/00149

(51) Int. Cl. B01D 46/00

(52) U.S. Cl. 95/277; 55/385.4; 55/385.3; 55/400

(57) ABSTRACT

The invention relates to an oil separator, in particular for application in a crankcase breather for an internal combustion engine, with a filter disc (1), fitted to a driven shaft (2). Gases from the crankcase pas through the filter disc (1). Oil and soot particles adhering to the filter disc (1) are spun off the turning filter disc (1).

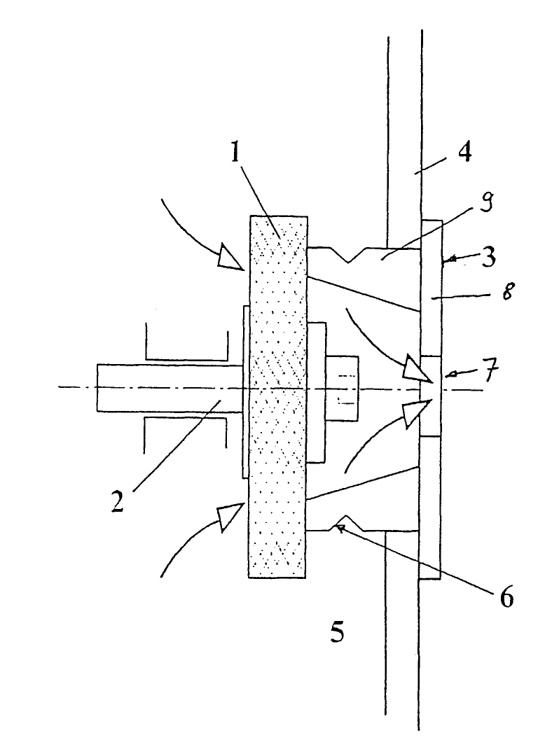

The invention relates to a rotatory-working oil separator that purifies the crankcase breather gases of an internal combustion engine.

Oil droplets and oil aerosols are a part of the blow-by gases from the crankcase breather of all internal combustion engines. When introducing these gases that contain oil into the suction area of the motor, fouling occurs in the subsequent components, which has a negative effect on the functioning of the motor components. The oil that was carried along must therefore be removed from the crankcase breather gas.

Usually, the oil separation from the crankcase gases occurs with the help of separators that consist of a texture of fibers or with the help of ray deflections on deflecting plates or a combination of these processes. In addition, superfine filters are used, which however work with a high differential pressure.

Cyclone separators need a relatively large installation space and, conditional upon principle, only work optimally in an operating point

Electrostatic filters require an additional electrical input and are relatively cost intensive. Moreover, these filters can not be used with combustible gases. Rotatory-working oil separators, in which the oil droplets are spun out with the help of impellers, is also known. They are mostly run with electric motors, air pressure turbines or oil pressure turbines.

The optimal design of the oil separator usually used causes considerable problems because the degree of oil separation and the differential pressure that appears depend on the oil content, the oil temperature, the droplet size distribution, the blow-by flow of gas, the pulsating current, the engine revolutions and the engine stress, and from the sudden revolution and stress changes etc. Therefore, plenum chambers and preliminary filter are still inserted in front of the actual oil separators. These require additional room and cause additional costs. Further cost results still from the oil container, the return valve and the oil return line to the engine's oil sump.

A fume separator mechanism is known from DE 43 30 912 A1, by which a body of rotation is furnished with a filter filling. Fume-forming particles should be hydroextracted by the body of rotation through the effect of centrifugal force in the radial direction. This fume separator mechanism requires however a reservoir and deflecting ribs for the fume-forming particles and is thus not suitable for the purification of blow-by gases. Furthermore, the body of rotation is arranged together with the driving motor inside the housing. This leads to the large dimensions of the fume separator mechanism.

A purifying apparatus is known from DE 196 37 431 A1, by which an air current with particulate solids is guided through a rotating perforated disk. The particulate solids should be seized by the perforated disk and radially spun outward. This purifying apparatus is however not suitable for the separation of liquid materials such as oil droplets or oil aerosols for the air.

The invention is based on the task of creating an oil separator that can guarantee a nearly complete oil separation from the crankcase breather gases under all operating conditions that can occur and at low differential pressure, and in doing so can be produced at low cost.

By the definition of the invention, this task is solved by the features of claim 1.

Through this, a filter disk is fastened to a shaft in the crankcase in such a way that the crankcase gases must pass through the filter disk. The oil and soot particles separated on the surface and on the way through the filter disk are spun off through the rotating disk and remain in the crankcase so that no oil collection area and no special oil return is necessary. The self-purifying ability of the rotating filter disk is so great that the differential pressure of the filter also does not substantially change during long running times.

Further features and advantages of the invention are parts of the subclaims as well as the of the description of the embodiment and the appertaining drawn FIGURE.

Oil separators for use in crankcase breathers of an internal combustion engine, which has a filter disk for the flow of gases to be purified, are especially cost-efficient if the filter disk according to claim 7 is fitted to a camshaft, a differential shaft or a crankshaft of an internal combustion engine. Through this, the oil separator as defined by the invention does not require any expensive power unit since at least one of the shafts mentioned in present in internal combustion engines anyway.

An especially advantageous use of a rotary filter disk for the flow of gases to be purified is the separation of oil droplets and oil aerosols from gases of a crankcase breather of an internal combustion engine. Such a filter disk can withstand the changing load conditions of the internal combustion engine and can clean itself for a long time. Thus the separation of oil droplets and oil aerosols from the gases of the crankcase breather is nearly maintenance-free. Soot particles are also spun off by the filter disk.

The invention allows for numerous embodiments. One of these is illustrated for further clarification of its basic principle in the drawing and is described as follows. This shows in a single FIGURE a filter disk 1, which is fitted to a shaft 2 in the crankcase space of a internal combustion engine that is not diagramed in any more detail. The flow direction of the crankcase breather gases is shown by arrows. The crankcase lead-through 3 is sealed into the crankcase wall 4 and touches the filter disk 1 with its end face. The case lead-in 3 is furnished with a dripping edge 6, so that the oil dripping at the crankcase wall 4 when the engine is shutdown will not reach the filter disk 1.

1. Oil separator, provided particularly for use in crankcase breathers of an internal combustion engine, provided with a filter disk through which the gases to be purified flow, characterized in that means are provided for generating a rotary movement of the filter disk and that an end face of the filter disk (1) abuts a projecting edge of a case lead-in (3).

2. Oil separator according to claim 1, characterized in that the filter disk (1) is secured to a driven shaft (2).

3. Oil separator according to claim 1 or 2, characterized in that the case lead-in (3) has a draining edge (6).

4. Oil separator according to at least one of the preceding claims, characterized in that the filter disk (1) is made of a fibrous material.

5. Oil separator according to at least one of the preceding claims, characterized in that the inner wall of the case lead-in (3) is funnel-shaped and is tapered towards an opening (7).

6. Oil separator according to at least one of the preceding claims, characterized in that the case lead-in (3) has a flange (8) with an adjacent connecting piece (9), and the connecting piece passes through a wall (4) of the case to be vented.

7. An oil separator with a filter disk through which the gases to be purified flow provided for use in a crankcase breather, characterized in that the filter disk (1) is secured to a camshaft, differential shaft or crankshaft of the internal combustion engine.

8. Use of a rotating filter disk through which the gases to be purified flow for separating oil droplets and oil aerosols of gases of a crankcase breather of an internal combustion engine.
